(19) United States
(12) Patent Application Publication
(10) Pub. No.: US 2018/0051862 A1
(43) Pub. Date: Feb. 22, 2018

(54) Improvements in Relation to Lighting

(71) Applicant: IC ONE TWO PTY LTD, Braeside, Victoria (AU)

(72) Inventor: Rolf Roald MEUMANN, Sunshine West (AU)

(21) Appl. No.: 15/555,565

(22) PCT Filed: Mar. 3, 2016
(86) PCT No.: PCT/AU2016/000064

§ 371 Date: Sep. 5, 2017

(30) Foreign Application Priority Data
Mar. 3, 2015 (AU) 2015900744

(51) Int. Cl. F21V 5/00; F21V 5/04; G03B 15/05

(52) U.S. Cl. CPC F21V 5/008; F21V 5/04; F21Y 2115/10; F21V 5/007; F21V 5/045; G03B 15/05

(57) ABSTRACT

A light assembly comprising a two dimensional array of light emitting diodes arranged to emit light in a forwards direction, and a light pipe means mounted in front of said array, wherein said light pipe means has a convex front face portion from which the light is beamed.

### TECHNICAL FIELD

This invention concerns light assemblies which utilize a two-dimensional array of white light emitting diodes (LEDs) as the source of light and which then focus or project the light in a homogeneous manner.

The invention particularly relates to highly compact and lightweight light assemblies which have a relatively high light output. Such assemblies are particularly adapted for photography purposes, particularly flash photography, where the artificial light provided needs to be evenly spread and of uniform colour. However such assemblies are also suited for many other purposes.

### BACKGROUND

For many purposes, and particularly for photography purposes, it is highly desirable for a light assembly to be as compact as possible, and in particular for the light assembly to be as short as possible in the direction of the throw of light.

Square or rectangular arrays of LEDs which have sufficiently high brightness for use with photographic equipment are becoming generally available. The LED array has overall the shape of a square or rectangular patch, and within that patch are distinctly brighter areas which correspond to individual LEDs. A two-dimensional (planar) array of light emitting diodes is a source of non-homogeneous light both in relation to the irradiance, which is the flux of radiant energy flowing from the light source, and in terms of the separation of colours from the LED array. Therefore such arrays do not produce a light which is distributed uniformly enough for high quality photographic purposes. Direct projection of the illuminated array through a conventional lens system does not overcome the non-homogencity of the light output.

The problem of non-uniformity of light output is particularly pronounced when arrays of spectrally different LEDs (such as RGB arrays) are used for broad illumination of objects. The problem is displayed when any mismatch in the irradiance or intensity profile in the light output produced by each individual LED produces a non-uniform colour distribution in overall light output. A simple RGB LED array may produce an output that has a whitish central spot surrounded by one or more rings that may be distinctly tinted.

One approach to reducing spatial non-uniformity of output from LEDs utilizes a to so-called integrating light pipe formed from an optically transmissive material and which blends the radiation of different colours to provide a uniform irradiance profile in the output.

Other approaches for reducing spatial non-uniformity include systems of mirrors or other reflectors. However such systems introduce a substantial reduction in efficiency. They are also bulky, heavy and awkward to use in portable photography situations.

There accordingly exists an unresolved problem for light assemblies in regard to the angular uniformity of the distribution of the light produced by LED arrays. The most important factor is the uniformity of the light distribution rather than its intensity or accuracy of colour distribution.

An aim of the present invention is to provide light assemblies which overcome or at least reduce these difficulties.

### SUMMARY OF INVENTION

Accordingly, in one aspect the invention provides a light assembly comprising:
a two dimensional array of light emitting diodes arranged to emit light in a forwards direction, and
a light pipe means mounted in front of said array,
   wherein:
said light pipe means has a convex front face portion from which the light is beamed.

A lens means may be mounted in front of said light pipe means. The light pipe means may be tapered divergently in the direction of light travel. A single light pipe may transmit the light from all the light emitting diodes in said array. Alternatively a separate convex front face portion may be provided for each said light emitting diode.

In another aspect the invention provides a light assembly comprising:
a two dimensional array of light emitting diodes arranged to emit light in a forwards direction,
a first lens means mounted in front of said array, and
a second lens means mounted in front of said first lens means,
   wherein:
said first lens means comprises a first wafer carrying a plurality of first lens elements, each one of said first lens elements overlying and axially aligned with a corresponding one of said light emitting diodes.

Preferably said second lens means comprises a second wafer carrying a plurality of second lens elements, each one of said second lens elements overlying and axially aligned with a corresponding one of said first lens elements.

Preferably said second lens elements are Fresnel lenses, each one of said Fresnel lenses overlying and axially aligned with a corresponding one of said first lens elements.

Preferably said second wafer is spaced from said first wafer.

In a further embodiment the invention comprises flash unit for photography comprising a light assembly according to any one of the previous claims.

### BRIEF DESCRIPTION OF DRAWINGS

In order that the invention may be more fully understood there will now be described, by way of example only, preferred embodiments and other elements of the invention with reference to the accompanying drawings where:

FIG. 1A is a diagram illustrating the overall spread of light from 49 elements in a 7×7 square array of LEDs;

FIG. 1B is an enlargement of the portion circled in FIG. 1A;

FIG. 2 is a diagram illustrating the spread of light when the LED array in FIG. 1 is to incorporated into a light assembly according to a first embodiment of the present invention which includes a glass lens in front of the LED array;

FIG. 3 is a diagram illustrating the spread of light when the LED array in FIG. 1 is incorporated into a light assembly according to a second embodiment of the present invention in which a Fresnel lens has been added in front of the glass lens;

FIG. 4 is an enlargement of the portion circled in FIG. 3 with the Fresnell lens illustrated stylistically;

FIGS. 5A to 5D are ray diagrams for individual LEDs in FIG. 4;

FIG. 6 is a perspective representation of the components shown in FIG. 4 with corresponding ray traces;

FIG. 7 is an illustration of two components incorporated in a third embodiment of the present invention;

FIG. 8 illustrates the spread of light when the components in FIG. 7 are used to produce the third embodiment;

FIG. 9 is a side view of the embodiment shown in FIG. 8;

FIG. 10 illustrates the operation of a light assembly according to a fourth embodiment of the present invention;

FIG. 11 is an enlargement of portion of FIG. 10;

FIG. 12 is an exploded representation of components in FIGS. 10 and 11;

FIG. 13 illustrates the distribution of light from a corner LED in the fourth embodiment;

FIG. 14 is an exploded representation of components in a fifth embodiment of the present invention;

FIG. 15 is a cross-section view through a camera flash unit according to a sixth embodiment of the present invention; and

FIG. 16 is an exploded view of the camera flash unit shown in FIG. 15.

Many of the drawings described above are simple side elevations so for clarity of illustration, only a single row of LEDs and light rays from that row of LEDs, are shown in those side elevation drawings.

### DESCRIPTION OF EMBODIMENTS

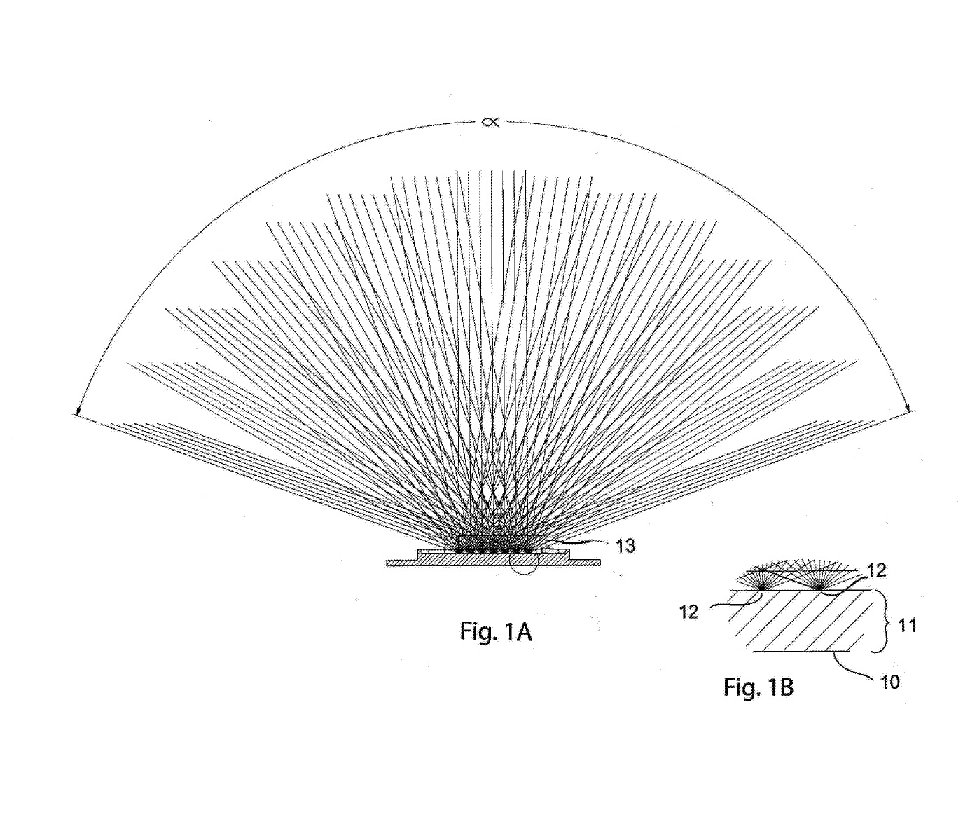

FIGS. 1A and 1B show ray traces for a 7×7 square array 10 of forty nine LEDs 12. The array 10 which forms the light source therefore has the form of a patch which is not uniformly lit. The LED array 10 is a commercially available integrated component in which the LEDs 12 are mounted on a backing plate 11. An upstanding rectangular metal strip 13 is part of the structure of the array 10 as purchased and is not relevant to the present invention.

It is apparent from FIG. 1A that the light output from the array 10 has a greater intensity towards the centre. The beam angle α of each LED 12 is about 140° but the irradiance is lower towards the outside of the projected beam when compared with the centre.

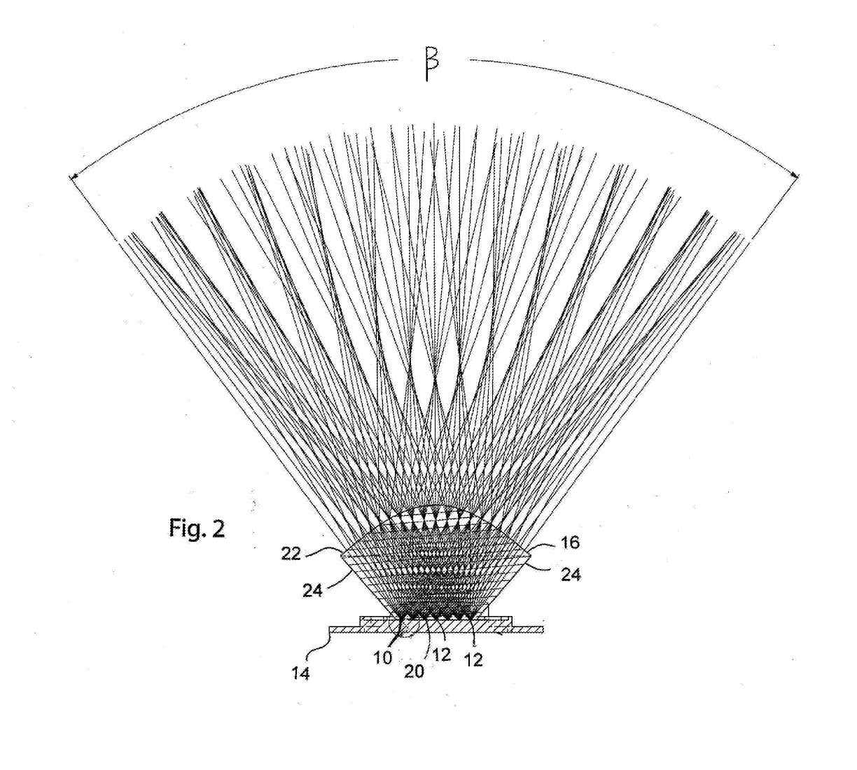

The light assembly 14 of the first embodiment of the invention shown in FIG. 2 incorporates a glass lens 16 into the configuration shown in FIG. 1A. The rear face of the lens 16 is flat but the front face 22 is convex parabolic. It can be seen that the light being emitted from the front of the lens has been compressed into a tighter beam angle β of only about 73° and is more evenly spread across the beam. The lens 16 is circular about its optical axis and its focus is well behind the plane of the LED array 10. The lens 16 importantly has a tapered conical side face 24 which gives the lens an overall shape similar to that of a cupcake. The lens 16 accordingly acts as a light pipe and for clarity is sometimes referred to as such elsewhere in this specification.

The rear face 20 of the lens is spaced as close as reasonably possible to the from face of the LEDs 12. In practice this means a space of about 0.5 mm is allowed to remain between the front face of the LEDs and the rear face of the lens in order to cater for the slightly different heights of individual LEDs which is a variation inherent in the manufacturing process of arrays of which the array 10 is one example.

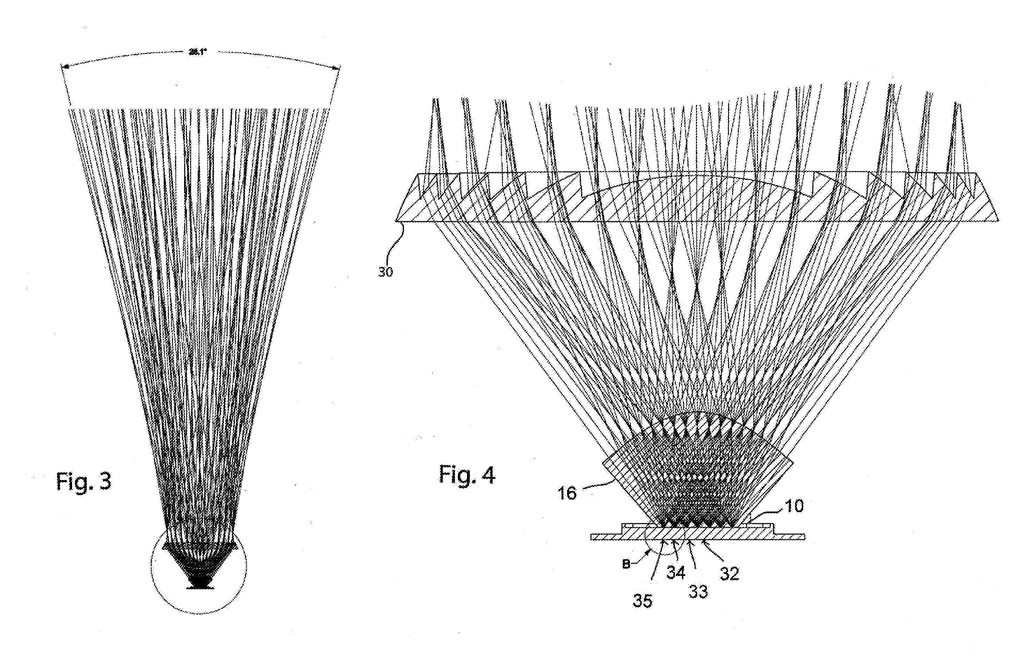

Aspects of the second embodiment of the invention are illustrated in FIGS. 3 to 6. To the configuration in FIG. 2 has been added a Fresnel lens 30. This produces a more focused beam of about 28° compared with the 73° beam spread of the first embodiment.

The distance between the centre of the front face of the lens 16 and the rear face of the Fresnel lens 30 is a function of the curvature of the convex face. The flatter the curvature of the front face, the further away the Fresnel lens needs to be.

The minimum distance of the Fresnel lens in FIG. 4 from the top face of the light pipe 16 is about twice the height of the glass lens forming the light pipe. Correct alignment of the main axis of the light pipe 16 and Fresnel lens 30 with the centre of the array is important. While about 90% transmission efficiency is achieved with proper alignment, the transmission can drop to 80% efficiency when not aligned.

The focal point of the lens 16 must be behind the LED array and it has been found that about 5 mm behind is ideal.

The rear face of the light pipe 16 is preferably less than 3 mm from the LED, more preferably less than 1 mm. Ideally it would be about 0.5 mm from the LED.

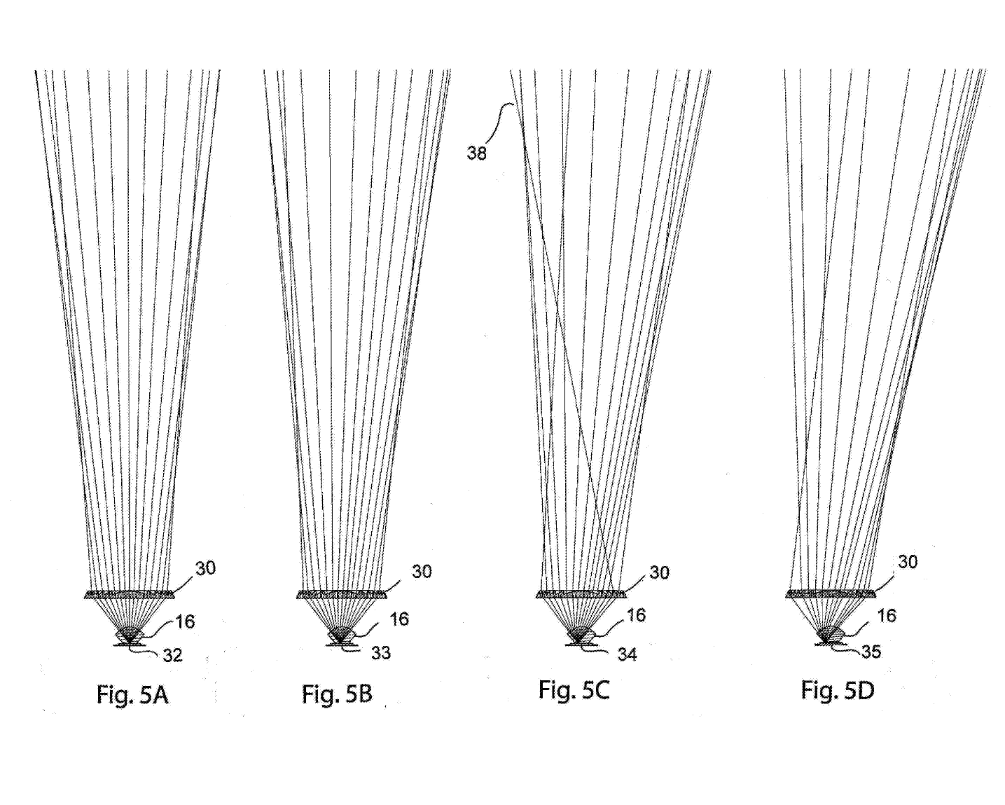

FIGS. 5A to 5D show ray traces for light travelling from different LEDs in one row of the array 10 shown in FIGS. 3 and 4. FIG. 5A shows ray traces from the central LED 32 of the seven LEDs in that row. FIG. 5B shows ray traces for an LED 33 adjacent the central LED 32. FIG. 5C shows ray traces for an LED 34 adjacent the LED 33 and FIG. 5D shows ray traces for an LED 35 at the end of that row. It can be seen that all the rays are confined to a compact beam and they are generally evenly spaced over the beam.

The thickness of the Fresnel lens 30 is exaggerated in the drawings because such exaggeration makes the ray-trace modelling software more reliable and the thickness does not affect the end result within the model. In FIG. 5C a rogue divergent ray 38 can be seen which is representative of the light which in practice escapes at odd angles due to hitting the sharp edges of the grooved structure of the Fresnel lens 30 and which results in losses.

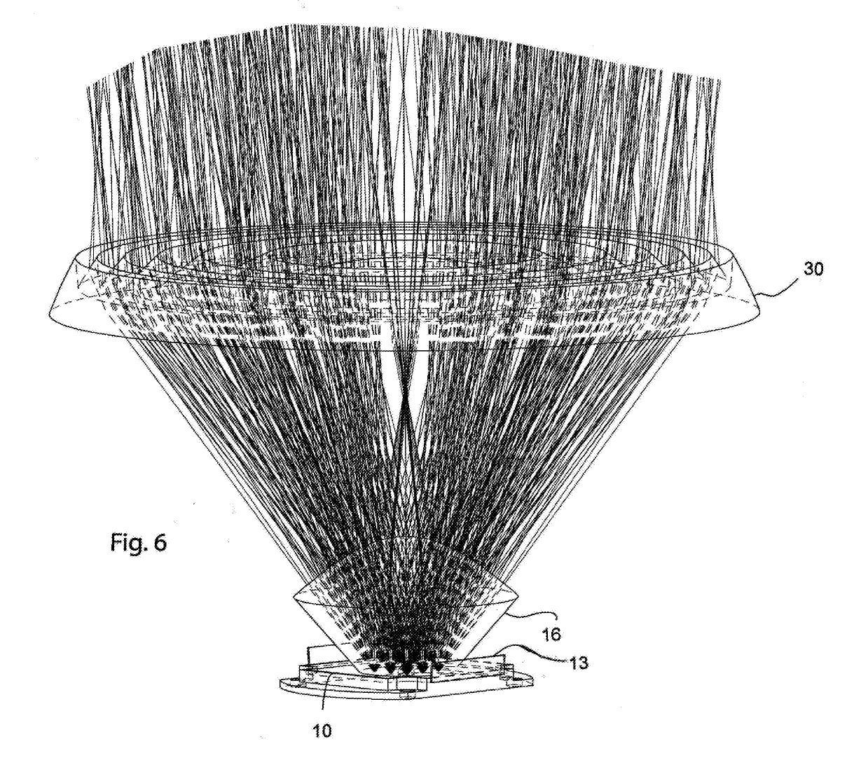

FIG. 6 shows a three dimensional representation of the view in FIG. 4.

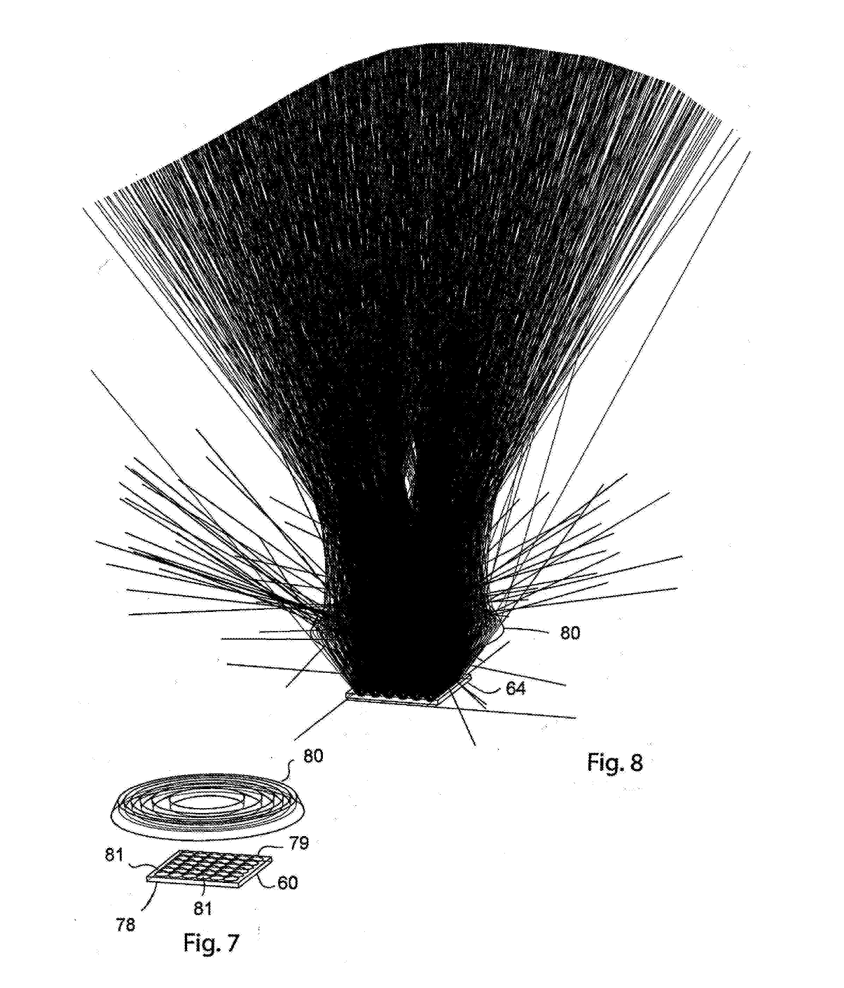

The components shown in FIG. 7 are a Fresnel lens 80 and a layered structure 78. The layered structure comprises a 6×6 square array 60 of thirty six LEDs overlaid with a wafer 79 of glass which has a flat underside but with a front side shaped to form thirty-six domes, each of the domes carrying a parabolic convex front surface and positioned over a respective LED. Each segment of the wafer comprising a single dome acts as an individual lens 81. The layered structure 78 has the same general form as the layered structure 88 in FIG. 11. The Fresnel lens 80 in FIG. 7 offers the advantage that it is smaller than the Fresnel lens 30 in FIG. 3 and so allows the light assembly to be more compact.

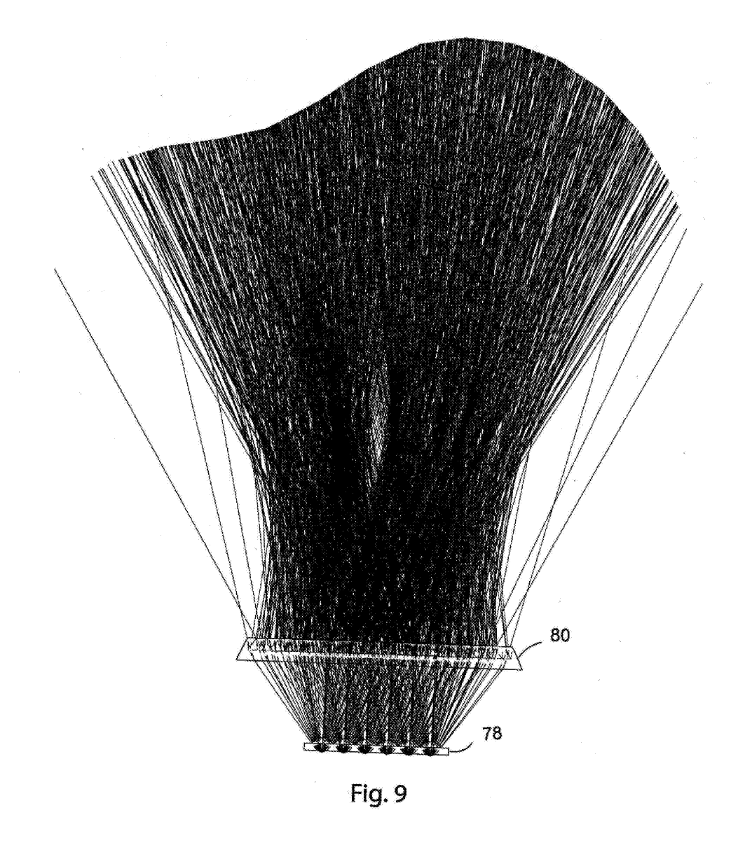

The layered structure 78 and the lens 80 are arranged as shown in FIGS. 8 and 9 for construction of the light assembly 64 according to the third embodiment. The light passing through the parabolic lenses 81 is then projected through the Fresnel lens 80. The particular detailed design of the Fresnel lens and of the front curvature of the parabolic lenses may be determined readily by a person skilled in the art once they know the above-described concept of the configuration.

So, instead of the light assembly shown in FIGS. 8 and 9 utilizing a single light guide for the combined output of all the LEDs in the array, each LED in the array 60 effectively has its own light guide with its own front convex surface. Using the wafer 79 instead of the thicker lens 16 makes the light assembly 64 substantially more compact, although manufacture of the glass wafer 79 would be more difficult than manufacture of the single lens 16 and ensuring accurate alignment of each LED with its respective dome would require accuracy.

It will be seen that a relatively small number of light rays shown in FIG. 8 miss the target area completely and this is indicative of the approximate 10% efficiency loss through the Fresnel lens 80.

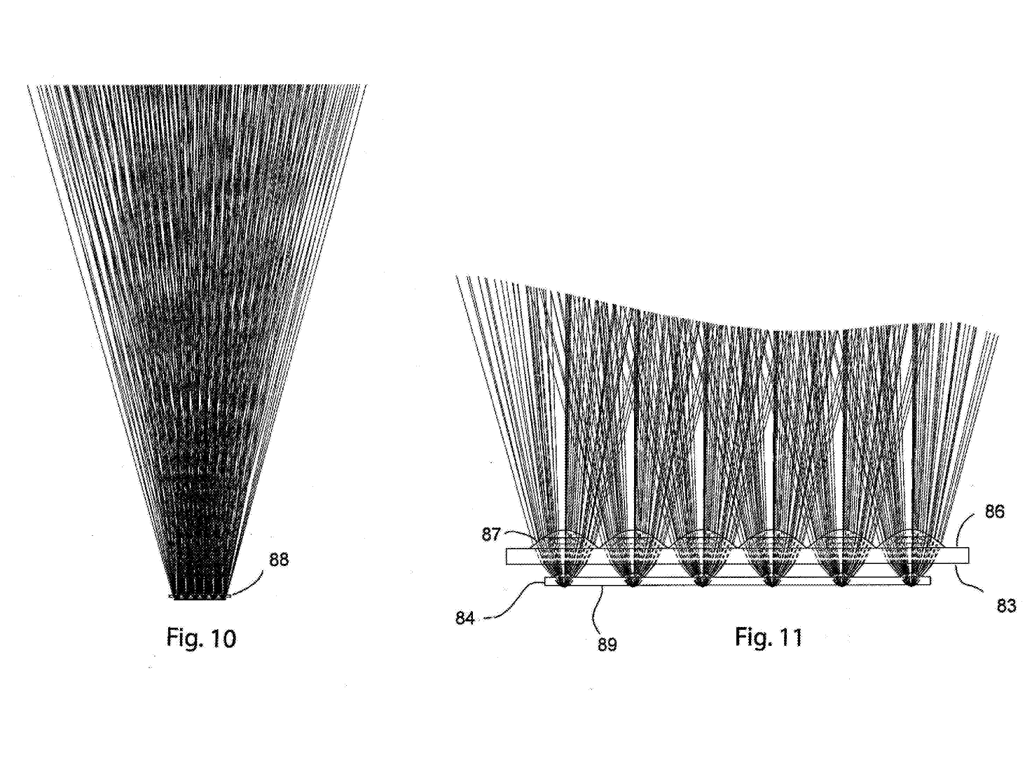

The fourth embodiment illustrated by FIGS. 10 to 12 utilizes a layered structure 83 of a square 6×6 array 60 of LEDs plus a rear glass wafer 84 which has a flat rear face 89 and 36 parabolic domes 85 on its front face which form individual lenses for each of the 36 LEDs 12. In front of the rear wafer 84 is mounted a front glass wafer 86 which has a flat rear face 90 and 36 parabolic domes 87 on its front face which form individual lenses which transmit light from the corresponding lenses/domes 85. The domes 87 on the front wafer are substantially larger than the domes 85. Because in this embodiment a Fresnel lens is not used, the wafer 84 is thicker than the other wafers described above.

The layered structure is 120 mm square, the LEDs are spaced at 18 mm centres. The rear wafer 84 is about 2 mm thick with its domes 84 rising about 1 mm therefrom. The front wafer 86 is about 4 mm thick with its domes 87 rising about 5 mm therefrom. The front wafer is spaced about 3 mm from the tops of the domes 85. The light beam diverges at 290.

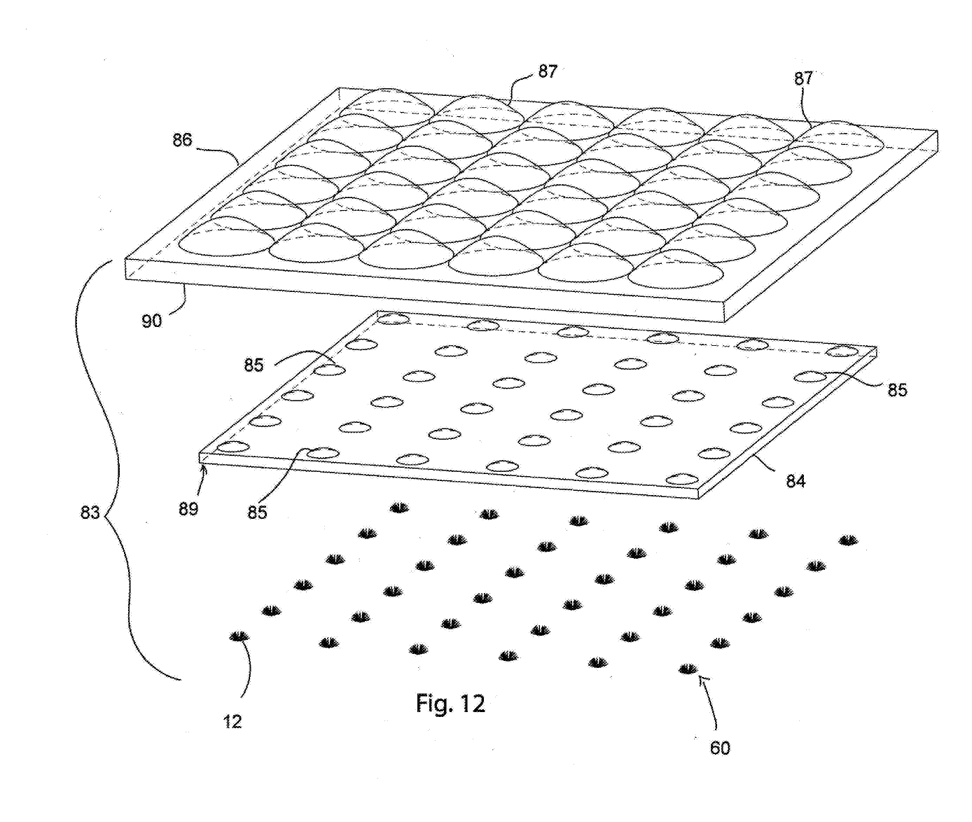

In FIG. 12 the individual LEDs are not shown. Instead short “tussocky” ray traces 17 are shown emanating from where the centre of the front of each LED would be.

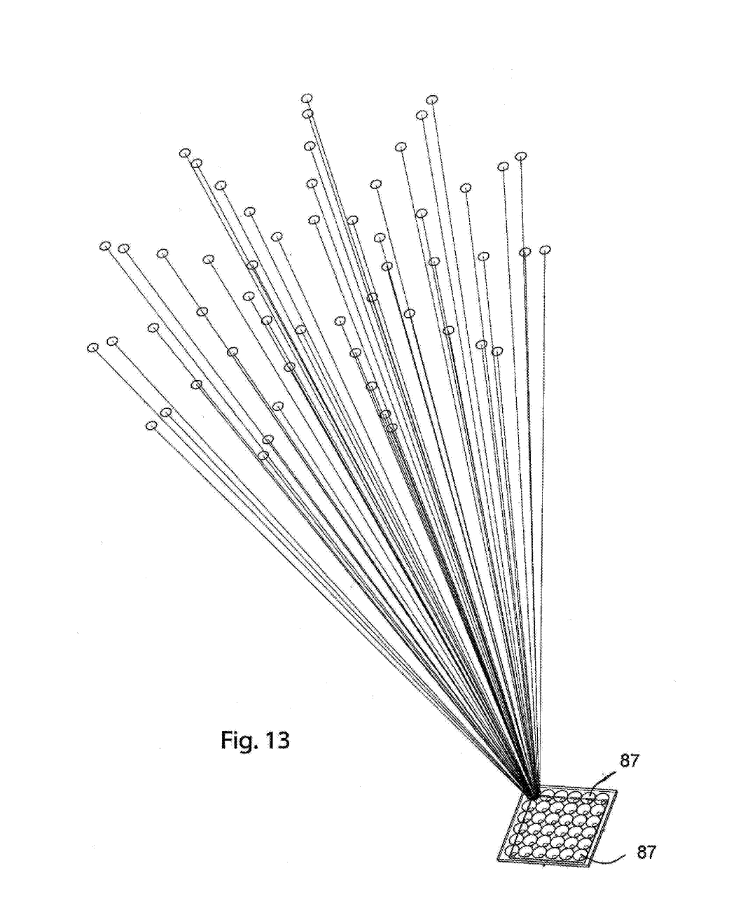

The ray diagram shown in FIG. 13 shows the distribution of rays for one particular LED in the fourth embodiment. Corresponding rays were replicated for each of the LEDs on the array in order to arrive at the distribution shown in FIGS. 10 and 11.

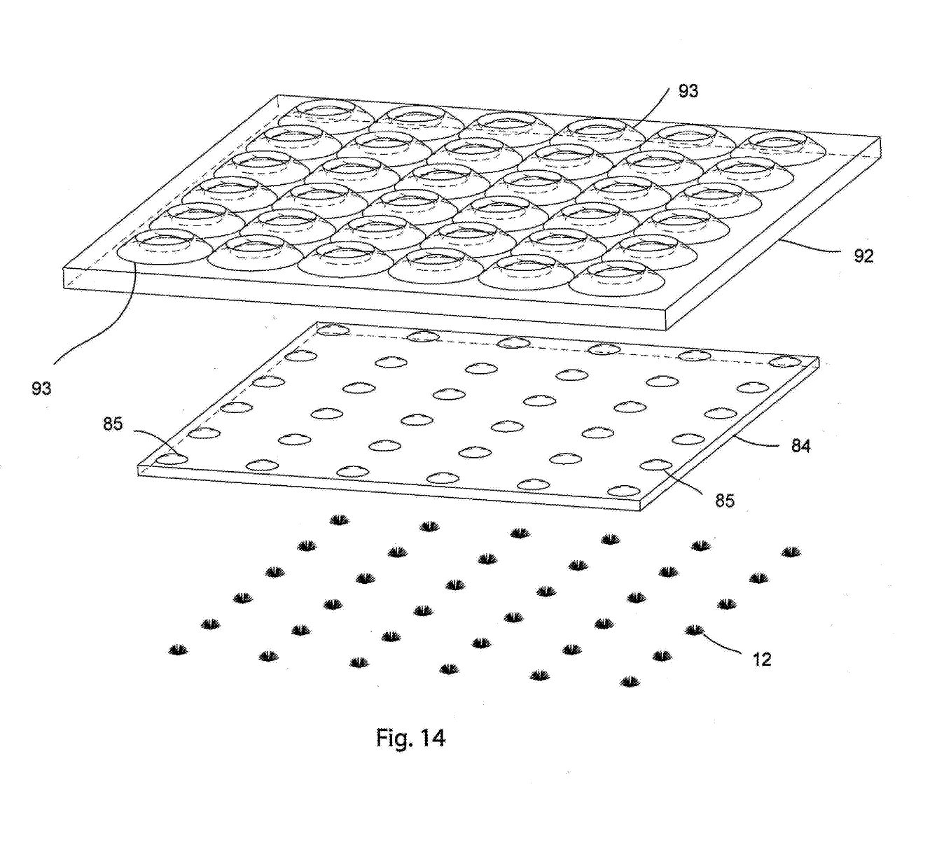

The representation shown in FIG. 14 is substantially the same as that in FIG. 12, the difference being that the front glass wafer 86 in FIG. 12 is replaced by a front plastic wafer 92 incorporating 36 small Fresnel lenses 93, there being one such Fresnel lens 93 aligned with each underlying lens 85. Again the Fresnell lenses 93 are shown stylistically rather than as an accurate visual representation.

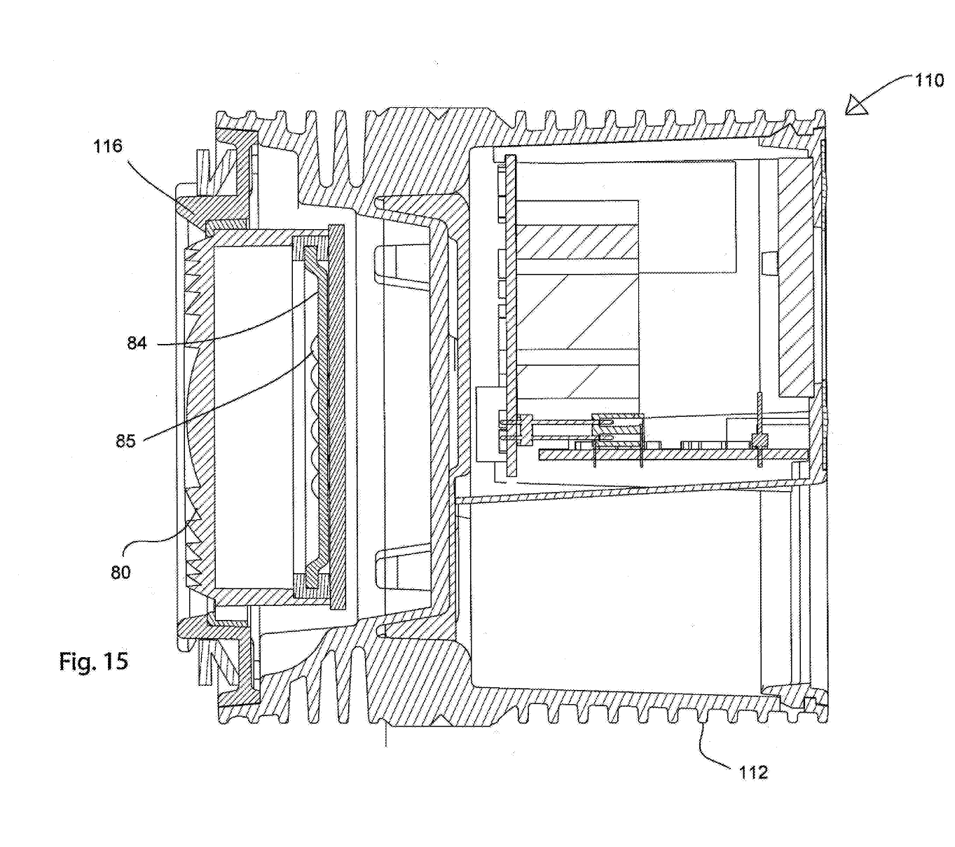

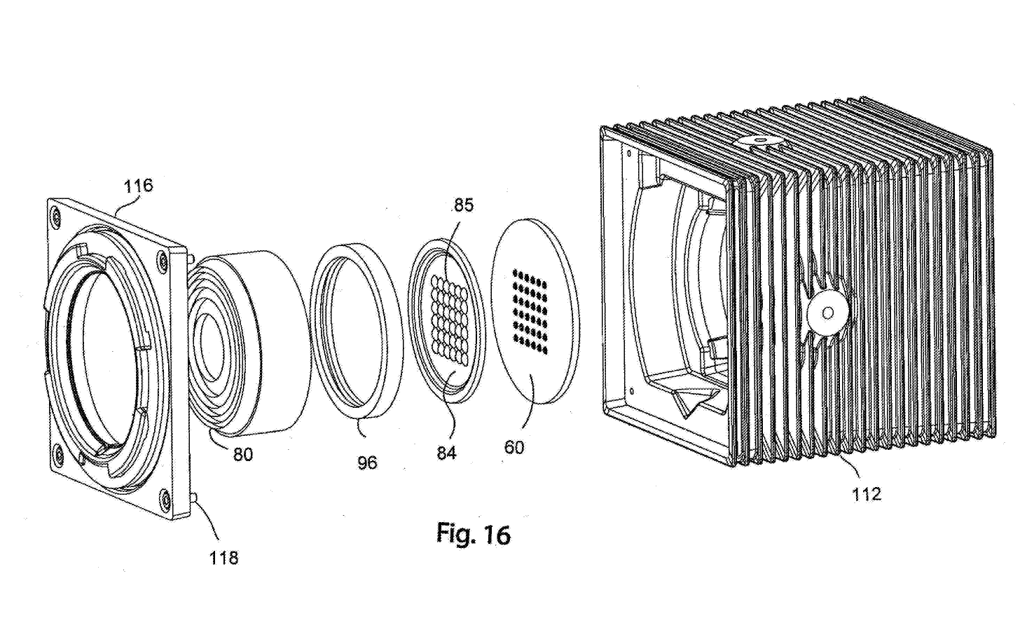

FIGS. 15 and 16 show a camera flash unit 110 which incorporates the LED array 60 and the wafer 84 shown in FIG. 12 but uses the Fresnel lens 80 shown in FIG. 7. The flash unit 110 has a main housing 112 formed from ribbed aluminium. The housing acts as a heat sink and includes external ribbing 114 to assist with conduction of heat away from the unit during operation.

The rear of the housing 112 houses the electronic circuitry for actuation and control of the LED array 60. The rear glass wafer 84 is mounted with its domes 85 axially aligned with their respective LEDs. A Fresnel lens 80 is mounted in front of that and the assembly held in position by a front cover plate 116 which is fastened by threaded fasteners 118 to the housing 112 clamping the lens, wafer, LED array and silicone rubber holding ring 96 therebetween.

The various embodiments described above work with an LED array emitting a white light, but would also work well if one or more of the LEDs was controlled to produce a colour tonal quality to the light. There have recently been put on the market two dimensional LED arrays where some, but not all of the LEDs are variable in colour and they could be used for the present invention. Although their colour consistency across the field of illumination may not be completely uniform, it would be satisfactory for most purposes.

While the invention has been described particularly in relation to lights for photography purposes, the invention would also be applicable in other areas such as theatre lighting where there is a need for a lighter and more compact LED light source than those presently available.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

For example, although the embodiments shown in the drawings are all examples using LED arrays of 6×6 or 7×7 configuration, alternative arrays which may be used in the present invention could have other square or rectangular configurations. A particularly desirable LED array would be a 150 watt LED array comprising 144 LEDs in a 25 mm square 12×12 array.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge in Australia.

1. A light assembly comprising:
a two dimensional array of light emitting diodes arranged to emit light in a forwards direction, and
a light pipe means mounted in front of said array,
wherein:
said light pipe means has a convex front face portion from which the light is beamed.

2. A light assembly according to claim 1 wherein a lens means is mounted in front of said light pipe means.

3. A light assembly according to claim 1 wherein said light pipe means is tapered divergently in the direction of light travel.

4. A light assembly according to claim 1 wherein a single light pipe transmits the light from all the light emitting diodes in said array.

5. A light assembly according to claim 2 wherein a separate said convex front face portion is provided for each said light emitting diode.

6. A light assembly comprising:
a two dimensional array of light emitting diodes arranged to emit light in a forwards direction,
a first lens means mounted in front of said array, and
a second lens means mounted in front of said first lens means,
wherein:
said first lens means comprises a first wafer carrying a plurality of first lens elements, each one of said first lens elements overlying and axially aligned with a corresponding one of said light emitting diodes.

7. A light assembly according to claim 6 wherein said second lens means comprises a second wafer carrying a plurality of second lens elements, each one of said second lens elements overlying and axially aligned with a corresponding one of said first lens elements.

8. A light assembly according to claim 7 wherein said second lens elements are Fresnel lenses, each one of said Fresnel lenses overlying and axially aligned with a corresponding one of said first lens elements.

9. A light assembly according to claim 7 wherein said second wafer is spaced from said first wafer.

10. A flash unit for photography comprising a light assembly according to claim 1.

11. A light assembly according to claim 2 wherein said light pipe means is tapered divergently in the direction of light travel.

12. A light assembly according to claim 2 wherein a single light pipe transmits the light from all the light emitting diodes in said array.

13. A light assembly according to claim 3 wherein a single light pipe transmits the light from all the light emitting diodes in said array.

14. A light assembly according to claim 8 wherein said second wafer is spaced from said first wafer.

15. A flash unit for photography comprising a light assembly according to claim 6.
